(19) United States
(12) Patent Application Publication
(10) Pub. No.: US 2025/0074781 A1
(43) Pub. Date: Mar. 6, 2025

(54) METHOD OF PRODUCING, SEPARATING, AND PURIFYING METAL SULFIDES

(71) Applicant: Solid Power Operating, Inc., Louisville, CO (US)

(72) Inventors: Brian E. Francisco, Arvada, CO (US); Samuel M. Oberwetter, Lafayette, CO (US); Benjamin A. Carlson, St. Paul, MN (US)

(21) Appl. No.: 18/818,374

(22) Filed: Aug. 28, 2024

Related U.S. Application Data
(60) Provisional application No. 63/534,985, filed on Aug. 28, 2023.

(51) Int. Cl. C01D 15/00

(52) U.S. Cl. CPC C01D 15/00

(57) ABSTRACT

Provided herein are methods for making Li₂S. The method includes combining metal polysulfides, metal sulfides, metal salts, elemental sulfur in a solvent to form a mixture and isolating Li₂S from the mixture. Provided herein are also methods for purifying the isolated Li₂S forming a high-purity Li₂S. Further provided herein are methods for making solid-state electrolytes.

### CROSS-REFERENCE TO RELATED APPLICATION

This application is related to and claims priority under 35 U.S.C. § 119 (e) from U.S. Patent Application No. 63/534,985 filed Aug. 28, 2023, titled “Method of Producing, Separating, and Purifying Metal Sulfides,” the entire contents of which is incorporated herein by reference for all purposes.

### TECHNICAL FIELD

This disclosure generally relates to a method of producing, separating, and purifying metal sulfides. This disclosure also generally relates to a method for making solid-state electrolytes.

### BACKGROUND

In recent years, our reliance on rechargeable batteries to power our phones, computers, and cars has deepened dramatically. Also, there are increasing demands for batteries to contain more power, to last longer, and to be more economical. To meet these growing demands, companies and research alike have focused on the solid-state rechargeable battery, specifically those that contain solid-state sulfide electrolytes.

One of the major reactants utilized in the synthesis of solid-state sulfide electrolytes is Lithium Sulfide (Li₂S). As this compound does not occur naturally, it must be made synthetically and the traditional synthetic routes require expensive precursors, expensive equipment, and may result in compounds of low purity. For example, Smith (U.S. Pat. No. 3,642,436) teaches reacting alkali metals with hydrogen sulfide or sulfur vapor, but this method requires expensive high purity lithium metal and the use of large quantities of hydrogen sulfide, which is a highly toxic gas. Dawidowski (DE102012208982) teaches reacting a lithium metal base with hydrogen sulfide in an organic solvent; however, this method too employs expensive precursors in the form of lithium organic compounds. Barker (U.S. Pat. No. 8,377,411) and Mehta (U.S. Pat. No. 6,555,078) both teach processes that use less expensive precursors but Barker's method requires expensive specialized processing equipment due to the corrosive nature of the process and Mehta's method requires the use of high temperatures and an aqueous solution, which would lead to hydrolysis of the lithium sulfide and a lower purity product. In order to overcome these problems, a more efficient and lower cost method of producing Li₂S is necessary. The present disclosure provides a robust process to produce lithium sulfides of high purity using inexpensive precursors and scalable processes.

### SUMMARY

Provided herein are methods of preparing Li₂S. The methods include combining Li₂Sₓ and Na₂S in a solvent to form a mixture, wherein x>1 and x<8; and, isolating a Li₂S reaction product from the mixture. In some embodiments, the solvent is an aprotic solvent including but not limited to THF, ACN, ethyl acetate, DMSO, acetone, DMF, DMA, chloroform, diethyl ether, diglyme, an ether, or a combination thereof.

In some embodiments, the method includes adding elemental sulfur (S₈), LiCl, LiBr, LiI, or a combination thereof to the mixture. In some embodiments, the elemental sulfur (S₈), NaCl, LiCl, Na₂Sₓ, or a combination thereof is recycled.

In some embodiments, the method includes adding P₂S₅ to the mixture. In some other embodiments, LiCl is added to the mixture. In yet other embodiments, Li₂SO₄, Li₂CO₃, LiOH, Li₂O, carbon, or a combination thereof are added to the mixture.

In some embodiments, the solvent includes pentane, hexane, heptane, octane, decane, undecane, xylene, toluene, or a combination thereof. In some embodiments, heat is applied to remove the solvent.

Some embodiments include isolating unreacted Li₂Sₓ and heating the Li₂Sₓ to form Li₂S. In some embodiments, the method includes recycling the unreacted Li₂Sₓ.

In some embodiments, the method includes removing from the mixture a salt selected from the group consisting of NaCl, LiCl, NaBr, NaI, KCl, KBr, KI, MgCl₂, MgBr₂, MgI₂, MgS, CaCl₂), CaBr₂, CaI₂, CaS and combinations thereof. In some embodiments, the salt is removed from the mixture by filtration.

In some embodiments, the method includes removing a Na₂S₃, Na₂S, or Na₂S₂ film from the isolated Li₂S reaction product.

In some embodiments, the method includes adding P₂S₅, elemental sulfur (S₈), NaCl, LiCl or a combination thereof to the mixture.

In some embodiments, the method includes yielding less than 0.1 H₂S gas per mole of Li₂S isolated.

In some embodiments, the method includes evaporating less than 10 wt % solvent per wt % of Li₂S isolated.

Further provided herein are methods of preparing Li₂S. The methods generally include combining Li₂Sₓ and Na₂S in a solvent to form a mixture, wherein x>1 and x<8, forming a Li₂S precipitate, and isolating a Li₂S reaction product from the mixture.

Further provided herein are methods of preparing Li₂S. The methods generally include combining LiCl and Na₂S_{y} in a solvent to form a mixture, wherein y>1 and y<5, adding elemental sulfur (S₈) or LiCl to the mixture, and isolating a Li₂S or Li₂Sₓ reaction product from the mixture, wherein x>1 and x<8.

In some embodiments, the method includes filtering from the mixture a salt selected from the group consisting of NaCl, LiCl, NaBr, NaI, KCl, KBr, KI, MgCl₂, MgBr₂, MgI₂, MgS, CaCl₂), CaBr₂, CaI₂, Ca and combinations thereof. In some embodiments, the salt is removed from the mixture by filtration. In other embodiments, the method includes adding P₂S₅ to the mixture.

Further provided herein are methods of preparing Li₂S. The methods generally include combining LiCl+Na₂S_{y} in a solvent to form a mixture, wherein y>1 and y<5, heating the mixture comprising a Li₂S or Li₂Sₓ reaction product, wherein x>1 and x<8; and isolating a Li₂S or Li₂Sₓ reaction product from the mixture. In some embodiments, the method further includes adding elemental sulfur (S₈) or LiCl to the mixture. In other embodiments, the method includes adding P₂S₅ to the mixture.

Further provided herein are methods of purifying Li₂S. The methods generally include adding Li₂SO₄, carbon, or a combination thereof to a solution comprising Li₂S and a solvent, adding elemental sulfur, and isolating a Li₂S reaction product from the mixture. In some embodiments, the initial purity of the Li₂S in solution is 70% (wt/wt) or less and the purity of the isolated Li₂S reaction product is at least about 90% (wt/wt). Exemplary solvents may include, for example, but are not limited to ethers, esters, nitriles, ketones, and alcohols. Ethers include but are not limited to tetrahydrofuran, diethyl ether, dibutyl ether, dipentyl ether, dimethoxyethane (DME), dioxane, anisole, or combinations thereof. Esters include but are not limited to ethyl acetate, ethyl butyrate, isobutyl acetate, butyl acetate, butyl butyrate, butyl propanoate, or combinations thereof. Nitriles may be one or more of and not limited to acetonitrile, propionitrile, butyronitrile, isobutyronitrile, or combinations thereof. Alcohols include but are not limited to methanol, ethanol, propanol, butanol, isopropanol, isobutanol, or combinations thereof.

In some embodiments, the solvent is an aprotic solvent. In other embodiments, the aprotic solvent includes THF, ACN, ethyl acetate, DMSO, acetone, DMF, DMA, chloroform, diethyl ether, diglyme, an ether, or a combination thereof. In some embodiments, the method includes adding elemental sulfur(S), LiCl, LiBr, LiI or a combination thereof to the mixture. In some embodiments, the method includes recycling the elemental sulfur (S₈), LiCl, or a combination thereof.

Further provided herein are compositions including at least 95% Li₂S and between 0.01% and 1.5% Li₂Sₓ, wherein x>1 and x<8.

Further provided herein are compositions including at least 20% Li₂S, at least 30% P₂S₅, and at least 20% Li₂Sₓ, wherein x>1 and x<8.

Further provided herein are compositions including comprising at least 20% Li₂S, and at least 30% Li₃PS₄, Li₇PS₆/Li₆PS₅Cl, Li₄PS₄I, Li_{5.5}PS_{4.5}ClBr_{0.5}, or combinations thereof.

### BRIEF DESCRIPTION OF DRAWINGS

The present disclosure may be understood by reference to the following detailed description taken in conjunction with the drawings briefly described below.

FIG. 1 shows a flow chart describing an exemplary method of the present disclosure.

FIG. 2 shows a flow chart describing an exemplary method of the present disclosure.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

As used herein, the term “high purity” or “high level of purity” may mean at least 85% pure, at least 90% pure, at least 91% pure, at least 92% pure, at least 93% pure, at least 94% pure, at least 95% pure, at least 96% pure, at least 97% pure, at least 98% pure, at least 99% pure, or at least 99.5% pure.

### Method of Synthesizing Metal Sulfide

The current disclosure provides a method of synthesizing a metal sulfide by allowing a metal polysulfide and a metal salt to dissolve in a solvent in which a “double exchange” occurs. The end result is the synthesis of a metal sulfide and one or more metal by-products where either one or more by-products or the metal sulfide may be filtered out either by the appropriate selection of solvent or by adding an anti-solvent then filtering out the undesirable product. The general reaction is:

1. First metathesis reaction in solvent

M1X₍ₛₒₗ₎+M2₂Sₓ₍ₛₒₗ₎→M2X₍ₛ₎+M1₂Sₓ₍ₛₒₗ₎

2. Filter to remove insoluble byproduct

M1₂Sₓ₍ₛₒₗ₎+M2X₍ₛ₎→M1₂Sₓ₍ₛₒₗ₎

3. Second metathesis reaction in solvent

M1₂Sₓ₍ₛₒₗ₎+M2₂S₍ₛₒₗ₎→M1₂S₍ₛ₎+M2₂Sₓ₍ₛₒₗ₎

4. Filter to remove insoluble metal sulfide

M1₂S₍ₛ₎+M2₂Sₓ₍ₛₒₗ₎→M2₂Sₓ₍ₛₒₗ₎

In the reactions above, x is a number greater than about 1 and less than about 8. In some embodiments, x may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7ss.9 or about 8.0.

In the above reactions, M1 and M2 are an alkali metal or an alkaline earth metal and X is a halide. Non-limiting examples of alkali metals include Li, Na, K, Rb, or Cs. Non-limiting examples of alkaline earth metals include Be, Mg, Ca, Sr, or Ba. Examples of metal salts include but are not limited to LiCl, NaCl, NaBr, NaI, KCl, KBr, KI, MgCl₂, MgBr₂, MgI₂, MgS, CaCl₂), CaBr₂, CaI₂, CaS and combinations thereof.

The above reactions may be carried out in an aprotic solvent. Aprotic solvents include but are not limited to THF, ACN, ethyl acetate, DMSO, acetone, DMF, DMA, chloroform, diethyl ether, diglyme, an ether, an alkane, substituted benzenes, or a combination thereof. Non limiting examples of suitable alkanes include pentane, hexane, heptane, octane, decane, or undecane. Non limiting examples of suitable substituted benzenes include xylene or toluene.

In one embodiment, the first step of the synthesis includes forming a mixture of a first alkali metal sulfide and a first alkali metal halide in an aprotic solvent. Next, the first alkali metal sulfide and the first alkali metal halide react in a metastasis reaction forming a second alkali metal halide and an alkali metal polysulfide. A suitable aprotic solvent is one in which the first alkali metal sulfide, the first alkali metal halide, and the alkali metal polysulfide are soluble, and the second alkali metal halide is insoluble. The second alkali metal halide is insoluble in the aprotic solvent and is removed from the reaction mixture by separation techniques like filtration. The alkali metal polysulfide is further reacted with a phosphorous sulfide the first alkali metal sulfide forming the metal sulfide. The resulting metal sulfide is insoluble in the aprotic solvent and is removed by separation techniques like filtration. The general reactions are:

1. First metathesis reaction in solvent

Na₂S₃₍ₛ₎+LiCl₍ₛₒₗ₎→NaCl₍ₛ₎+Li₂S₃₍ₛₒₗ₎

2. Filter to remove byproduct

NaCl₍ₛ₎+Li₂S₃₍ₛₒₗ₎→Li₂S₃₍ₛₒₗ)

3. Second metathesis reaction in solvent

Li₂S₃₍ₛₒₗ₎+Na₂S₍ₛ₎→Li₂S₍ₛ₎+Na₂S₃₍ₛₒₗ₎

4. Filter to remove product

Li₂S₍ₛ₎+Na₂S₃₍ₛₒₗ₎→Na₂S₃₍ₛₒₗ₎

In another embodiment, the second metathesis reaction may be summarized by the following equation:

3. Second metathesis reaction in solvent

2NaSH₍ₛ₎+Li₂Sₓ₍ₛₒₗ₎→Na₂Sₓ₍ₛₒₗ₎+Li₂S₍ₛ₎+H₂S

4. Filter to remove product

Na₂Sₓ₍ₛₒₗ₎+Li₂S₍ₛ₎→Na₂Sₓ₍ₛₒₗ₎

In another embodiment, the second metathesis reaction may be summarized by the following equation:

3. Second metathesis reaction in solvent

K₂S₍ₛ₎+Li₂Sₓ₍ₛₒₗ₎→K₂Sₓ₍ₛₒₗ₎+Li₂S₍ₛ₎

4. Filter to remove product

K₂Sₓ₍ₛₒₗ₎+Li₂S₍ₛ₎→K₂Sₓ₍ₛₒₗ₎

In another embodiment, the second metathesis reaction may be summarized by the following equation:

3. Metathesis reaction in aprotic solvent

CaS₍ₛ₎+Li₂Sₓ₍ₛₒₗ₎→CaSₓ₍ₛₒₗ₎+Li₂S₍ₛ₎

4. Filter to remove product

CaSₓ₍ₛₒₗ₎+Li₂S₍ₛ₎→CaSₓ₍ₛₒₗ₎

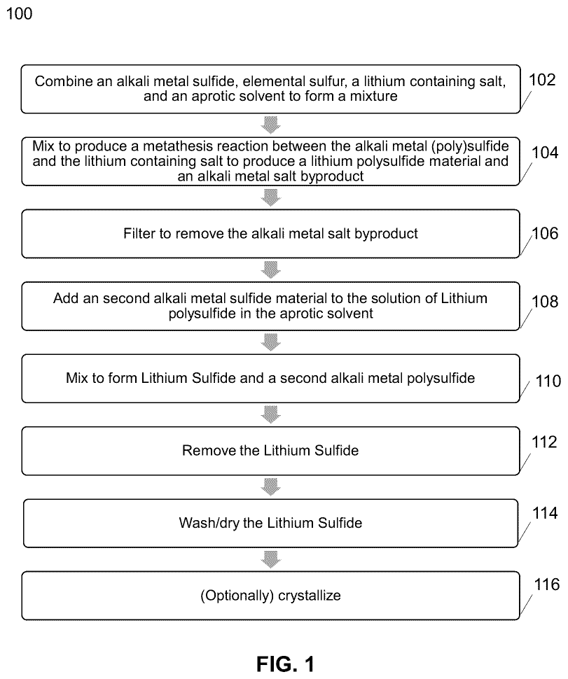

As shown in FIG. 1, in some embodiments, the first step of the synthesis includes forming a mixture of a first metal sulfide, a first metal salt, and elemental sulfur in an aprotic solvent 102. Next, the first metal sulfide, the first metal salt, and sulfur react in a metastasis reaction forming a second metal salt and a metal polysulfide 104. A suitable aprotic solvent is one in which the first metal sulfide, the first metal salt, elemental sulfur, and the metal polysulfide are soluble, and the second metal halide is insoluble. The second metal halide is insoluble in the aprotic solvent and is removed from the reaction mixture by separation techniques like filtration 106. The metal polysulfide is further reacted with the first metal sulfide forming the metal sulfide 108. The resulting metal sulfide is insoluble in the aprotic solvent and is removed by separation techniques like filtration 112, washed, and dried 114. After drying the final metal sulfide product, most if not all of the metal polysulfide should decompose into metal sulfide and the elemental sulfur should evaporate. In some embodiments, the resulting metal sulfide is optionally crystallized 116. The general reactions are:

1. First metathesis reaction in solvent

M1X₍ₛₒₗ₎+M2₂S_{y(sol)}+S₂(s)→M2X₍ₛ₎+M12S_{y+2(sol)}

2. Filter to remove insoluble byproduct

M2X₍ₛ₎+M1₂S_{y+2(sol)}→M1₂S_{y+2(sol)}

3. Second metathesis reaction in solvent

M1₂S_{y+2(sol)}+M2₂S_{y(sol)}→M1₂S₍ₛ₎+M2₂S_{y+2(sol)}

4. Filter to remove insoluble metal sulfide

M1₂S₍ₛ₎+M2₂S_{y+2(sol)}→M2₂S_{y+2(sol)}

In the reactions above, y is a number greater than about 1 and less than about 5. In some embodiments, y may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the above reactions, M1 and M2 are an alkali metal or an alkaline earth metal and X is a halide. Non-limiting examples of alkali metals include Li, Na, K, Rb, or Cs. Non-limiting examples of alkaline earth metals include Be, Mg, Ca, Sr, or Ba. Examples of metal salts include but are not limited to LiCl, NaCl, NaBr, NaI, KCl, KBr, KI, MgCl₂, MgBr₂, MgI₂, MgS, CaCl₂), CaBr₂, CaI₂, CaS and combinations thereof.

The above reactions may be carried out in any suitable solvent. Exemplary solvents include but are not limited to ethers, esters, nitriles, ketones, and alcohols. Ethers include but are not limited to tetrahydrofuran, diethyl ether, dibutyl ether, dipentyl ether, dimethoxyethane (DME), dioxane, anisole, or combinations thereof. Esters include but are not limited to ethyl acetate, ethyl butyrate, isobutyl acetate, butyl acetate, butyl butyrate, butyl propanoate, or combinations thereof. Nitriles may be one or more of and not limited to acetonitrile, propionitrile, butyronitrile, isobutyronitrile, or combinations thereof. Alcohols include but are not limited to methanol, ethanol, propanol, butanol, isopropanol, isobutanol, or combinations thereof.

The above reactions may be carried out in an aprotic solvent. Aprotic solvents include but are not limited to THF, ACN, ethyl acetate, DMSO, acetone, DMF, DMA, chloroform, diethyl ether, diglyme, an ether, an alkane, substituted benzenes, or a combination thereof. Non limiting examples of suitable alkanes include pentane, hexane, heptane, octane, decane, or undecane. Non limiting examples of suitable substituted benzenes include xylene or toluene.

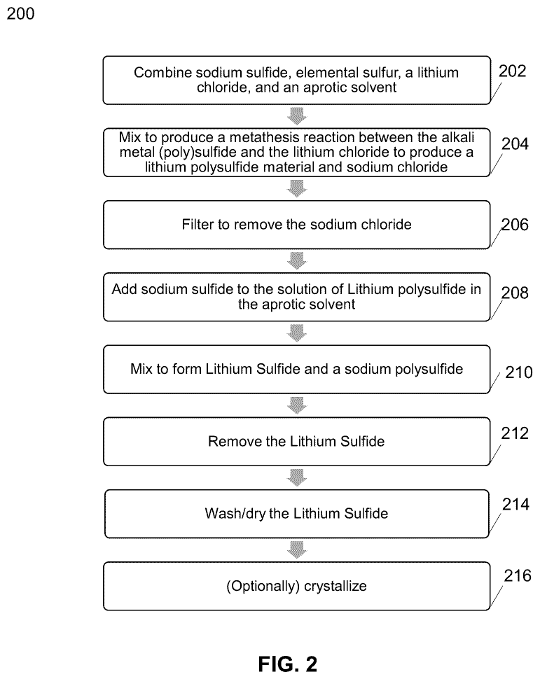

One embodiment of the process is shown in FIG. 2. In one embodiment, the first step of the synthesis includes forming a mixture of a sodium sulfide and a lithium chloride in an aprotic solvent. Elemental sulfur is added to the mixture 202. Next, the sodium sulfide, elemental sulfur, and lithium chloride react in a metastasis reaction forming sodium chloride and lithium polysulfide. A suitable aprotic solvent is one in which sodium sulfide, lithium chloride, and lithium polysulfide are soluble and sodium chloride is insoluble. Sodium chloride is insoluble in the aprotic solvent and is removed from the reaction mixture by separation techniques like filtration 206. Sodium sulfide is added to the solution of lithium polysulfide in the aprotic solvent 208. Lithium polysulfide reacts with sodium sulfide forming lithium sulfide 210. The resulting lithium sulfide is insoluble in the aprotic solvent and is removed by separation techniques like filtration 212. The lithium sulfide is further washed and dried 214. After drying the lithium sulfide, most if not all of the lithium polysulfide should decompose into lithium sulfide and the elemental sulfur should evaporate. In some embodiments, the lithium sulfide is optionally crystallized 216. The reactions are:

5. First metathesis reaction in aprotic solvent

Na₂S₍ₛ₎+LiCl₍ₛₒₗ₎+S₂₍ₛ₎→NaCl₍ₛ₎+Li₂S₃₍ₛₒₗ₎

6. Filter to remove byproduct

NaCl₍ₛ₎+Li₂S₃₍ₛₒₗ₎→Li₂S₃₍ₛₒₗ₎

7. Second metathesis reaction in solvent

Li₂S₃₍ₛₒₗ₎+Na₂S₍ₛ₎→Li₂S₍ₛ₎+Na₂S₃₍ₛₒₗ₎

8. Filter to remove product

Li₂S₍ₛ₎+Na₂S₃₍ₛₒₗ₎→Na₂S₃₍ₛₒₗ₎

In some embodiments, less than one H₂S gas per mole of Li₂S isolated may be generated. In some embodiments, 0.1 H₂S gas per mole of Li₂S isolated may be generated.

In some embodiments, technical grade LiCl may be used for the first metathesis reaction.

In some embodiments, heat may be applied to the reaction mixture to remove the solvent by evaporation. In other embodiments, less than 10 wt % solvent may be evaporated per wt % of Li₂S.

In some embodiments, unreacted reactants may be recycled. Examples of unreacted reactants include elemental sulfur, NaCl, LiCl, Na₂S (x), Li₂S (x), or combinations thereof. On example of reusing LiCl and Na₂S (x) in one or more embodiments is shown below.

In other embodiments, unreacted Li₂Sₓ may be isolated and subsequently heated to between about 50° C. to about 500° C. to form Li₂S.

In some embodiments, the method includes removing from the mixture a salt selected from the group consisting of NaCl, LiCl, NaBr, NaI, KCl, KBr, KI, MgCl₂, MgBr₂, MgI₂, MgS, CaCl₂), CaBr₂, CaI₂, CaS and combinations thereof. The salts may be removed by techniques such as filtration.

In some embodiments, the Li₂S forms a precipitate which is subsequently isolated from the product mixture. The isolated Li₂S may include Li₂S, a mixture of Li₂S and Li₂S₂, Li₂S—LiCl composite, contaminants, and combinations thereof. Examples of contaminants include a film of metal sulfides/polysulfides, NaCl, or LiCl. Non limiting examples of the metal sulfides/polysulfides film includes Na₂S₃, Na₂S, Na₂S₂, or combinations thereof.

The isolated Li₂S may include contaminants such as unreacted starting materials. The contaminants include NaCl, LiCl, elemental sulfur, and Na₂S. The weight percent (wt %) of NaCl in the isolated Li₂S depends on the solvent used. The weight percent of NaCl in the isolated Li₂S may range from about 3 wt % to about 30 wt %. The weight percent of LiCl in the isolated Li₂S may be between about 0% and less than about 10 wt %. The weight percent of Na₂S in the isolated Li₂S may be greater than about 5 wt % and less than about 10 wt %. The weight percent of elemental sulfur in the isolated Li₂S may be less than about 1 wt %. Method of purification of metal sulfide

The current disclosure also provides a method of purifying the metal sulfide forming a high-purity metal sulfide by adding a mixture of lithium salts, carbon, and sulfur to the metal sulfide in a solvent allowing the formation of an insoluble metal polysulfide. The insoluble metal polysulfide is isolated from the reaction mixture and further reacted with a second metal sulfide to form the high-purity metal sulfide by a sulfur exchange reaction.

One embodiment of the present disclosure describes the purification of the isolated Li₂S obtained from any of the above reactions. The purity of the isolated Li₂S in a solvent is between about 50 wt/wt % to about 70 wt/wt %. The purity of the Li₂S may be about 50 wt/wt %, about 51 wt/wt %, about 52 wt/wt %, about 53 wt/wt %, about 54 wt/wt % about 55 wt/wt %, about 56 wt/wt %, about 57 wt/wt %, about 58 wt/wt %, about 59 wt/wt %, about 60 wt/wt %, about 61 wt/wt %, about 62 wt/wt %, about 63 wt/wt %, about 64 wt/wt % about 65 wt/wt %, about 66 wt/wt %, about 67 wt/wt %, about 68 wt/wt %, about 69 wt/wt %, to about 70 wt/wt %.

In some embodiments to purify the isolated Li₂S and form a high-purity Li₂S, carbon, elemental sulfur, lithium containing material with low solubility in the solvent, or a combination thereof may be added to the second metathesis reaction forming a Li₂S-lithium containing material-carbon composite. The lithium containing material may include lithium salts. Non limiting examples of lithium salts include lithium halides, lithium sulfate (Li₂SO₄), lithium carbonates (Li₂CO₃), lithium hydroxide (LiOH), or lithium oxide (Li₂O). Non limiting examples of lithium halides include LiF, LiCl, LiBr, or LiI. The addition of sulfur to the Li₂S-lithium containing material-carbon composite in an aprotic solvent result in the formation of soluble Li₂Sₓ. The Li₂Sₓ may be filtered from the other materials. Na₂S may then be added to the solution converting the Li₂Sₓ to Li₂S, resulting in a Li₂S precipitate. The Li₂S may be filtered and dried resulting in a high-purity Li₂S product.

In one embodiment, Li₂SO₄ and carbon are added to LiS₂ forming a Li₂S—(Li₂SO₄-carbon) composite. An additional sulfur source is added to the composite solution. The insoluble Li₂S binds to the sulfur forming a solution of Li₂Sₓ. After all the Li₂S is in solution, the Li₂SO₄-carbon is filtered away. The sulfur source includes elemental sulfur or Li₂Sₓ. Na₂S is added to the solution of Li₂Sₓ forming an insoluble Li₂S precipitate. The insoluble Li₂S precipitate is filtered out of the reaction mixture and is a high-purity Li₂S product.

The purity of the high-purity Li₂S product is about 90 wt/wt % or greater. The purity may be about 90 wt/wt %, about 91 wt/wt %, about 92 wt/wt %, about 93 wt/wt %, about 94 wt/wt %, about 95 wt/wt %, about 96 wt/wt %, about 97 wt/wt %, about 98 wt/wt %, about 99 wt/wt %, or about 100 wt %.

In one embodiment, the high-purity Li₂S comprises at least about 95 wt % Li₂S and between about 0.01 wt % and about 1.5 wt % Li₂Sₓ, wherein x>1 and x<8.

Solid-state electrolyte

The current disclosure also provides a method of synthesizing a solid-state electrolyte. The solid-state electrolyte is formed by dissolving Na₂Sₓ, elemental sulfur, and LiCl in a solvent and forming a NaCl precipitate and Li₂Sₓ. NaCl is removed and P₂S₅ added to the remaining Li₂Sₓ solution. The addition of P₂S₅ to the Li₂Sₓ solution results in the formation of a solid-state electrolyte. To solid-state electrolyte is dried to remove the solvent.

P₂S₅ reacts with Li₂S on a 1:1 molar basis forming a Li₂P₂S₆ material. The addition of Li₂S into this mixture results in the formation of electrolyte materials such as Li₃PS₄ and Li₇PS₆. If one or more lithium halide (LiCl, LiBr, LiI) is introduced, electrolyte materials such as Li₆PS₅Cl, Li₄PS₄I, and Li_{5.5}PS_{4.5}ClBr_{0.5} may be made.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

The term “about” will be understood by persons of ordinary skill in the art and will vary to some extent on the context in which it is used. As used herein when referring to a measurable value such as an amount, a temporal duration, and the like, the term “about” is meant to encompass variations of ±10%, including ±5%, ±1%, and ±0.1% from the specified value, as such variations are appropriate to perform the disclosed methods.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

The disclosure will now be illustrated with working examples, and which are intended to illustrate the disclosure and not intended to restrict any limitations on the scope of the present disclosure. Unless defined otherwise, all technical and scientific terms used herein have the same meaning as commonly understood to one of ordinary skill in the art to which this disclosure belongs.

The disclosure will now be illustrated with working examples, and which are intended to illustrate the disclosure and not intended to restrict any limitations on the scope of the present disclosure. Unless defined otherwise, all technical and scientific terms used herein have the same meaning as commonly understood to one of ordinary skill in the art to which this disclosure belongs.

### EXAMPLES

### Example 1

Na₂S and elemental sulfur were added to a vial of THF to make a Na₂Sₓ material in solution where 3≤x≤5. The mixture was stirred and subsequently filtered to remove any unreacted materials. LiCl was added to the Na₂Sₓ solution where the molar ratio between LiCl and Na₂Sₓ was about 2:1 and the mixture was stirred forming NaCl and Li₂Sₓ. NaCl was removed by centrifuging the mixture and decanting the Li₂Sₓ solution. Na₂S was then added to the Li₂Sₓ solution resulting in the formation of Li₂S precipitated. The Li₂S was removed from the reaction mixture by centrifuging the mixture and decanting the Na₂Sₓ solution was decanted. The isolated Li₂S was dried.

### Example 2

Na₂S and elemental sulfur were added to a vial of diglyme. The mixture was stirred for and subsequently filtered to remove any unreacted materials. LiCl was added to the Na₂Sₓ solution and the mixture was stirred forming NaCl and Li₂Sₓ. NaCl was removed by centrifuging the mixture and decanting the Li₂Sₓ solution. Na₂S was then added to the Li₂Sₓ solution resulting in the formation of Li₂S precipitated. The Li₂S was removed from the reaction mixture by centrifuging the mixture and decanting the Na₂Sₓ solution was decanted. The isolated Li₂S was dried.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

1. A method of preparing Li₂S, the method comprising:
combining Li₂Sₓ and Na₂S in a solvent to form a mixture, wherein x>1 and x<8; and
isolating a Li₂S reaction product from the mixture.

2. The method of claim 1, wherein the solvent is an aprotic solvent, and wherein the aprotic solvent comprises THF, ACN, ethyl acetate, DMSO, acetone, DMF, DMA, chloroform, diethyl ether, diglyme, an ether, or a combination thereof.

3. (canceled)

4. The method of claim 1, the method comprising adding elemental sulfur (S₂), LiCl, LiBr, LiI, or a combination thereof to the mixture.

5. The method of claim 4, the method comprising recycling the elemental sulfur (S₂), NaCl, LiCl, Na₂Sₓ, or a combination thereof.

6. The method of claim 1, the method comprising adding P₂S₅ to the mixture.

7. The method of claim 1, the method comprising adding LiCl to the mixture.

8. The method of claim 1, the method comprising adding Li₂SO₄, Li₂CO₃, LiOH, Li₂O, carbon, or a combination thereof to the mixture.

9. The method of claim 1, wherein the solvent comprises pentane, hexane, heptane, octane, decane, undecane, xylene, toluene, or a combination thereof.

10. The method of claim 1, further comprising applying heat to remove the solvent.

11. The method of claim 1, further comprising isolating unreacted Li₂Sₓ and heating the Li₂Sₓ to form Li₂S.

12. The method of claim 11, the method comprising recycling the unreacted Li₂Sₓ.

13. The method of claim 1, the method comprising removing from the mixture a salt selected from the group consisting of NaCl, LiCl, NaBr, NaI, KCl, KBr, KI, MgCl₂, MgBr₂, MgI₂, MgS, CaCl₂), CaBr₂, CaI₂, CaS and combinations thereof.

14. The method of claim 13, wherein the salt is removed from the mixture by filtration.

15. The method of claim 1, the method comprising removing a Na₂S₃, Na₂S, or Na₂S₂ film from the isolated Li₂S reaction product.

16. The method of claim 13, the method comprising adding P₂S₅, elemental sulfur (S₂), NaCl, LiCl or a combination thereof to the mixture.

17. The method of claim 1, the method comprising yielding less than 0.1 H₂S gas per mole of Li₂S isolated.

18. The method of claim 1, the method comprising evaporating less than 10 wt % solvent per wt % of Li₂S isolated.

19. (canceled)

20. A method of preparing Li₂S, the method comprising:
combining LiCl+Na₂S_{y} in a solvent to form a mixture, wherein y>1 and y<5;
adding elemental sulfur (S₂) or LiCl to the mixture; and
isolating a Li₂S or Li₂Sₓ reaction product from the mixture, wherein x>1 and x<8.

21. The method of claim 19, the method comprising filtering from the mixture a salt selected from the group consisting of NaCl, LiCl, NaBr, NaI, KCl, KBr, KI, MgCl₂, MgBr₂, MgI₂, MgS, CaCl₂), CaBr₂, CaI₂, Ca and combinations thereof.

22. The method of claim 21, wherein the salt is removed from the mixture by filtration.

23. The method of claim 20, the method comprising adding P₂S₅ to the mixture.

24. (canceled)

25. (canceled)

26. (canceled)

27. A method of purifying Li₂S, the method comprising:
adding Li₂SO₄, carbon, or a combination thereof to a solution comprising Li₂S and a solvent;
adding elemental sulfur or and,
isolating a Li₂S reaction product from the mixture.

28. The method of claim 27, wherein the initial purity of the Li₂S in solution is 70% (wt/wt) or less and the isolated Li₂S reaction product is at least about 90% (wt/wt).

29. The method of claim 27, wherein the solvent is an aprotic solvent, and wherein the aprotic solvent comprises THF, ACN, ethyl acetate, DMSO, acetone, DMF, DMA, chloroform, diethyl ether, diglyme, an ether, or a combination thereof.

30. (canceled)

31. The method of claim 27, the method comprising adding elemental sulfur(S), LiCl, LiBr, LiI or a combination thereof to the mixture.

32. The method of claim 31, the method comprising recycling the elemental sulfur (S₂), LiCl, or a combination thereof.

33. A composition comprising at least 95% Li₂S and between 0.01% and 1.5% Li₂Sₓ, wherein x>1 and x<8.

34. (canceled)

35. (canceled)
